(19) United States
(12) Patent Application Publication
(10) Pub. No.: US 2006/0175815 A1
(43) Pub. Date: Aug. 10, 2006

(54) Assembly for a vehicle steering wheel

(75) Inventors: Stefan Faeth, Aschaffenburg (DE); Andreas Kienzner, Wiesen (DE); Ralph Frisch, Moembris (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/339,167

(22) Filed: Jan. 25, 2006

(30) Foreign Application Priority Data
Feb. 10, 2005 (DE) 20 2005 002 153.9

(51) Int. Cl. B60R 21/203; H01R 39/00

(52) U.S. Cl. 280/731; 439/15; 439/164

(57) ABSTRACT

An assembly for a vehicle steering wheel having a stationary central part includes a gas bag module (10). A clock spring (20) is arranged on the gas bag module (10). The clock spring (20) forms a pre-assembled installation unit together with the gas bag module (10).

### TECHNICAL FIELD

The invention relates to an assembly for a vehicle steering wheel having a stationary central part.

### BACKGROUND OF THE INVENTION

In steering wheels having a stationary central part, a gas bag module can be provided thereon with a gas bag which does not necessarily have to be arranged symmetrically to the centre of rotation of the steering axis. As the orientation of the gas bag as it is unfolding from the stationary gas bag module is certain from the outset, asymmetrical gas bag shapes having better restraining characteristics can be used.

However, when such a steering wheel is fitted, the installation of the gas bag module is problematic, in particular because of the cabling of the gas bag module. A clock spring can be used for the cabling, which is pre-mounted on the upper side of the steering wheel hub facing the driver. (The structure and function of a clock spring are familiar to the specialist in the art and are not therefore explained in further detail here). A prerequisite for fastening the steering wheel is that the steering spindle or the steering spindle nut are accessible. In the case of a clock spring having a small diameter, this accessibility is however, not necessarily guaranteed.

It is an object of the invention to avoid an obstruction during the installation of a steering wheel having a gas bag module and a clock spring.

### BRIEF SUMMARY OF THE INVENTION

According to the invention an assembly for a vehicle steering wheel having a stationary central part comprises a gas bag module. A clock spring is arranged on the gas bag module. The clock spring forms a pre-assembled installation unit together with the gas bag module. The provision of an assembly in which the clock spring is pre-mounted on the gas bag module, i.e. not on the steering wheel hub, ensures that the steering spindle or the steering spindle nut are freely accessible during the installation of the steering wheel. A particular advantage of the invention can be seen in that the gas bag module can be constructed as a component of a stationary central part of the steering wheel without altering the steering column/steering wheel interface.

### BRIEF DESCRIPTION OF THE DRAWINGS

FIG. 1 shows a side view of an assembly according to the invention; and

FIG. 2 shows a perspective view of the assembly of FIG. 1.

### DETAILED DESCRIPTION OF THE PREFERRED EMBODIMENT

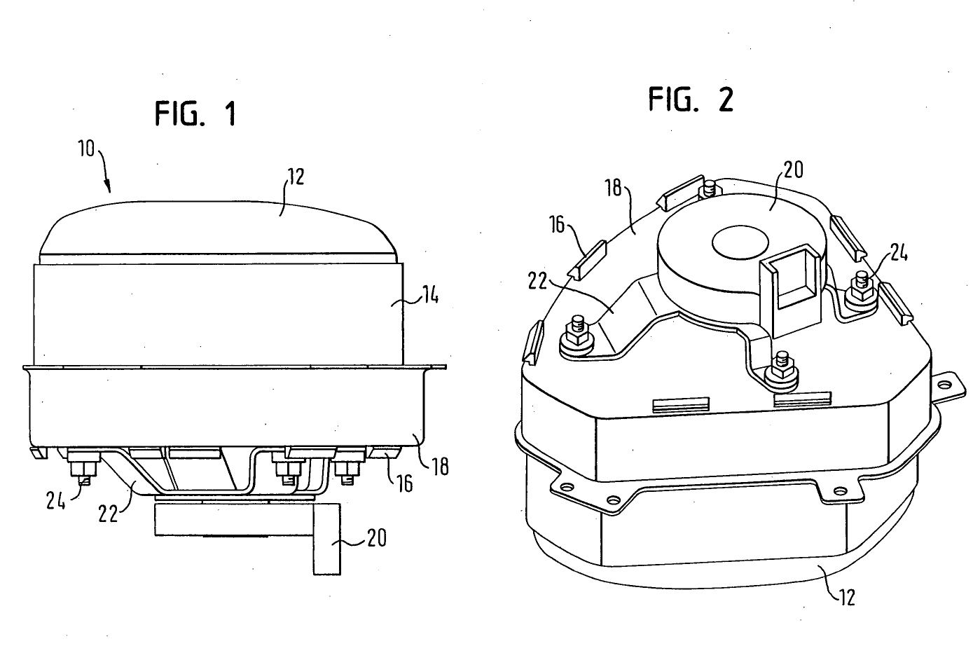

In FIGS. 1 and 2 a gas bag module 10 is shown for a steering wheel which has a stationary central part. The front side of the gas bag module 10 facing the driver (with reference to the installed state) is covered by a covering cap 12. The covering cap 12 has an encircling side wall 14 with detent projections 16. The detent projections 16 engage behind corresponding recesses in a gas generator carrier 18 such that the covering cap 12 is securely arrested on the gas generator carrier 18.

A clock spring 20, provided for the cabling of the gas bag module 10, is fastened on the rear side of the gas bag module 10 facing away from the driver, more precisely on the gas generator carrier 18. For this, the clock spring 20 has fastening projections 22 which are screwed to the gas generator carrier 18. The fastening points 24 on which a gas bag holding plate of the gas bag module 10 is also screwed to the gas generator carrier 18 can be advantageously selected for the fastening of the clock spring.

The gas bag module 10 and the clock spring 20 which is fastened thereon form a pre-assembled installation unit, i.e. they are mounted as a single unit on installation of the steering wheel.

1. An assembly for a vehicle steering wheel having a stationary central part, the assembly comprising a gas bag module, a clock spring being arranged on the gas bag module, the clock spring forming a pre-assembled installation unit together with the gas bag module.

2. The assembly according to claim 1, wherein the clock spring is arranged on the rear side of the gas bag module facing away from the driver.

3. The assembly according to claim 2, wherein the clock spring is fastened to a gas generator carrier of the gas bag module.

4. The assembly according to claim 3, wherein the gas bag module further comprises a gas bag holding plate, the clock spring being connected with the gas generator carrier at fastening sites at which also the gas bag holding plate is connected with the gas generator carrier.
